(19) United States
(12) Patent Application Publication
(10) Pub. No.: US 2025/0171334 A1
(43) Pub. Date: May 29, 2025

(54) 3-D COMPOSITIONS WITH INTEGRATED CONDUCTIVE POLYMERS FOR WATER PURIFICATION AND OIL SEPARATION

(71) Applicant: BOARD OF REGENTS, THE UNIVERSITY OF TEXAS SYSTEM, Austin, TX (US)

(72) Inventors: Donglei FAN, Austin, TX (US); Weigu LI, Austin, TX (US)

(21) Appl. No.: 18/948,640

(22) Filed: Nov. 15, 2024

Related U.S. Application Data
(62) Division of application No. 17/612,867, filed on Nov. 19, 2021, now abandoned.
(60) Provisional application No. 62/850,279, filed on May 20, 2019.

(51) Int. Cl. C02F 1/28; B01D 1/00; B01D 5/00; B01J 20/26; B01J 20/28; B01J 20/30; C02F 1/04; C02F 1/14; C02F 101/32; C02F 103/00; H01B 1/12

(52) U.S. Cl. CPC C02F 1/288; B01D 1/0035; B01D 5/006; B01D 5/009; B01J 20/261; B01J 20/28045; B01J 20/3085; C02F 1/043; C02F 1/14; C02F 1/285; H01B 1/127; H01B 1/128; B01J 2220/44; C02F 2101/32; C02F 2103/007

(57) ABSTRACT

Disclosed herein are conductive polymer-based composites. The composites include a conductive polymer entangled in a thin substrate. The composites may be hydrophobic or hydrophilic. The hydrophilic composites may be used as solar steamers for water purification, and the hydrophobic composites can be used to sequester hydrophobic materials, such as oil, from watery mixes.

### CROSS-REFERENCE TO RELATED APPLICATION

This application is a divisional of U.S. application Ser. No. 17/612,867, filed on Nov. 19, 2021, which is a § 371 Application of PCT/US2020/033761, filed on May 20, 2020, which claims the benefit of U.S. Provisional Application 62/850,279, filed on May 20, 2019, the contents of which are hereby incorporated in their entireties.

### STATEMENT OF GOVERNMENT SUPPORT

This invention was made with government support under Grant no. CMMI1563382 awarded by the National Science Foundation. The government has certain rights in the invention.

### FIELD OF THE INVENTION

The invention is directed to conductive polymer-based compositions, and applications for solar assisted water purification and for sequestration of hydrophobic substances, such as oil, from watery mixes.

### BACKGROUND

Demand for clean water is soaring due to population growth, global industrialization, increased life standard, and depletion of natural resources. Solar steaming shows great potencies as a clean, renewable and sustainable technology for water production due to the abundance of solar energy that reaches individuals, homes, and large facilities. Over the past five years, a number of photothermal materials with designed chemistry and structures have been investigated for high-efficiency solar steaming. The studied materials range from plasmonic metal nanoparticles (NPs), to carbonaceous materials. Some reported materials exhibit excellent performances; however, many of them suffer limitations due to the utilization cost of noble metals, or the integration of complex or fragile nanostructures. For some materials, the fabrication involved e-beam deposition, synthesis and reduction of graphene oxide (GO), chemical vapor deposition of graphene foams, and freeze-drying for aerogels, which can be time consuming and costly for manufacturing. There is a compelling interest in developing low-cost and manufacturable photothermal materials to realize the full potential of solar steaming techniques for practical applications. Recently, efforts have been made on exploiting biomass materials including woods, and carbonized mushrooms/bamboos/fruit peels, for cost-effective and scalable solar steaming systems.

Besides developing low-cost photothermal materials, it is of paramount importance to design solar steaming-collection systems that can be efficient as well as portable to address the needs of people on individual levels. Three dimensional (3D) superstructures with large surface areas, which are often designed for energy and environment applications, have also demonstrated enhanced water evaporation rates due to the improved transpiration pathways compared to 2D structures. Some 3D solar steamers also exploit environmental energy and reach 100% efficiency in solar-to-vapor energy transfer. Despite high solar-thermal conversion efficiencies and water evaporation rates shown in some studies, the amount of actually collected clean water can be greatly compromised once the solar steamers are utilized in a steam collection setup. The huge discrepancy between the evaporation rate in an open system and the collection rate in an enclosed collection system can be ascribed to the reduced solar irradiation intensity resulted from partial reflection, absorption of solar light by water steam and collection device, incomplete steam condensation and water collection during transportation, as well as increased external pressure during steaming in a closed system. Innovative design and prototyping of a portal water steaming-collection system with a high collection efficiency are desirable for applications of solar-steaming on individual levels.

There remains a need for improved solar steamers with enhanced water purification rates and efficiencies.

### SUMMARY

Disclosed here are composites including a conductive polymer entangled in a substrate. The composites are useful both for solar steaming water purifications, as well as sequestering hydrophobic materials from watery mixtures.

The details of one or more embodiments are set forth in the descriptions below. Other features, objects, and advantages will be apparent from the description and from the claims.

### BRIEF DESCRIPTION OF THE FIGURES

FIG. 1A depicts digital photograph of a PPy origami rose. FIG. 1B depicts fabrication process of PPy origami. FIG. 1C depicts SEM images of cellulose paper and FIG. 1D depicts SEM images of PPy-coated cellulose paper.

FIG. 2A depicts digital photos of a series of designed PPy origamis. The side and top views of PPy origamis are shown in the first and second rows, respectively. FIG. 2B depicts simplified reflection scheme of parallel light beams on PPy origamis corresponding to (2A). The multiple reflections are shown inside the folded petals with different number of folds. FIG. 2C depicts optical absorption of cellulose paper and different PPy origami structures. FIG. 2D depicts the estimated specific surface area normalized by the projected area (blue column) and dark evaporation rate (red square) of different PPy origamis.

FIG. 3A depicts mass change of water versus time at 1 kW m−2 solar illumination for different PPy origamis. FIG. 3B depicts solar steam water evaporation rate b-1) and solar-thermal energy conversion efficiency b-2) under 1 Sun. FIG. 3C depicts the highest temperatures on the top surfaces of different PPy origamis versus time. FIG. 3D depicts typical infrared photos of different PPy origamis: 2D Disk (top), AF-8F (middle), and artificial rose (bottom).

FIG. 4A depicts mass change rate of evaporated water (in blue) and collected water (in red) via steaming with AF-8F origami at different reduced pressures tested. FIG. 4B depicts schematic photographs of the designed low-pressure solar steam-collection system. FIG. 4C depicts digital photographs of the designed low-pressure solar steam-collection system. FIG. 4D depicts pressure maintenance in the solar steaming-collection unisystem versus time during water collection. FIG. 4E depicts mass change rate of evaporated water (in blue) and collected water (in red) via steaming with origami rose at pressures of 1 and 0.17 atm.

FIG. 5A depicts reduction of copper concentration after steaming at ≈0.17 atm. FIG. 5B depicts quality tests of the Colorado River water before and after treatment with solar steaming at a reduced pressure of 0.17 atm. FIG. 5C depicts bacterial tests of water from the Colorado River before and after solar steaming at a reduced pressure of 0.17 atm. FIG. 5D depicts quality tests of ocean water collected from the Gulf of Mexico before and after treatment with solar steaming at a pressure of 1 atm and a reduced pressure of 0.17 atm, showing the water quality meeting the WHO standards.

FIG. 6 depicts folding patterns to prepare samples AF-8F.

FIG. 7 depicts a pattern to prepare an origami rose.

FIG. 8 depict a digital photo of a PPy origami of 20 cm.

FIG. 9A depicts Raman spectra of cellulose paper (brown) and PPy coated cellulose paper (blue). FIG. 9B depicts EDS of cellulose paper (b-1) and PPy coated cellulose paper (b-2).

FIG. 10 depicts digital photographs of a series of PPy origamis in test.

FIG. 11 depicts mass change versus time with different origamis at dark condition.

FIG. 12 depicts water collection rates normalized by that in an ambient pressure with AF-8F utilized for solar steaming (blue); boiling temperatures of water at different reduced pressures (red).

FIG. 13 depicts a solar steamer including a reservoir for impure water, capillary means, and solar steamer.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes-, from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Disclosed herein are conductive polymers entangled in a substrate. In some cases, the substrate can be a flexible thin-film, while in others the substrate can be an absorbent sponge Suitable flexible thin-film substrates include air-laid paper, polysulfone membranes, cellulose papers, a polyvinylidene fluoride (PVDF) membrane, craft paper, printing paper, thin sponge, cotton cloth, and combinations thereof. Cellulosic substrates can be preferred, for instance in thicknesses ranging from 0.001″ to 0.02″, from 0.002″ to 0.02″, from 0.003″ to 0.02″, from 0.004″ to 0.02″, from 0.0015 to 0.02″, from 0.005″ to 0.02″, from 0.006″ to 0.02″, from 0.007″ to 0.02″, from 0.008″ to 0.02″, from 0.009″ to 0.02″, from 0.01″ to 0.02″, from 0.012″ to 0.02″, from 0.0014 to 0.02″, from 0.015″ to 0.02″, from 0.001″ to 0.01″, from 0.002″ to 0.01″, from 0.003″ to 0.01″, from 0.004″ to 0.012″, from 0.0015 to 0.01″, from 0.005″ to 0.012″, from 0.006″ to 0.01″, from 0.007″ to 0.01″, from 0.008″ to 0.01″, from 0.009″ to 0.01″, from 0.001″ to 0.007″, from 0.002″ to 0.007″, from 0.003″ to 0.007″, from 0.004″ to 0.007 from 0.005″ to 0.007″. Suitable sponges include polyurethanes, polyesters, and melamine sponges.

In some embodiments, the conductive polymer can be one or more of a poly(aniline), poly(pyrrole), poly(thiophene), poly(seleophene), poly(furan), or poly(azepine). It is also possible to use copolymers of any of the above, either random, repeating, or block copoylmers. In some instances, the conductive polymer has the structure:

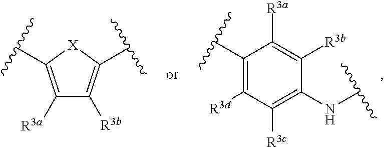

wherein X is NH, S, O, Se; R^{3a}, R^{3b}, R^{3c}, and R^{3d} are independently selected from hydrogen, C₁₋₈ alkyl, C₁₋₈alkoxy, and wherein either R^{3a} and R^{3b} or R^{3c} and R^{3d} may together form a ring. In a preferred embodiment, X is NH, and R^{3a} and R^{3b} are each hydrogen.

The conductive polymers entangled in a substrate can be obtained by a polymerizing a suitable monomer in the presence of flexible thin-film substrate. In some embodiments, the flexible thin-film substrate can be submerged in a solution of the suitable monomer for a period of time sufficient to disperse the monomer through the bulk of the substrate. An oxidant can then be added, polymerizing the monomer such that it is entangled in the substrate. In some cases, the solvent can be water, although organic co-solvents can be used for water-insoluble monomer units. A preferred oxidant is ammonium persulfate, which can be use in approximately 1:1 mole ratio relative to the suitable monomer. In other cases, the oxidant can be provided in a stoichiometric excess of the suitable monomer.

The suitable monomer can be provided in the solution at a concentration measured against the surface area of the thin-film substrate. For instance, the polymerizable monomer can be provided at a concentration of 0.01-2 mmol per cm² of substrate, 0.05-2 mmol per cm² of substrate, 0.05-1.5 mmol per cm² of substrate, 0.05-1.0 mmol per cm² of substrate, 0.05-0.5 mmol per cm² of substrate, 0.1-2 mmol per cm² of substrate, 0.5-2 mmol per cm² of substrate, 1-2 mmol per cm² of substrate, 0.01-2 mmol per cm² of substrate, 0.01-1 mmol per cm² of substrate, 0.01-0.5 mmol per cm² of substrate, 0.01-0.251 mmol per cm² of substrate, 0.01-0.1 mmol per cm² of substrate, or 0.01-0.05 mmol per cm² of substrate.

The entangled composites prepared according to the aforementioned processes is hydrophilic, and especially efficient at converting solar energy to heat. As such, the composites can be used as solar steamers for water purification. As the composite is irradiation by the sun, it heats up, increasing the vaporization of any water in contact with the composite. The water vapor can be condensed and collected.

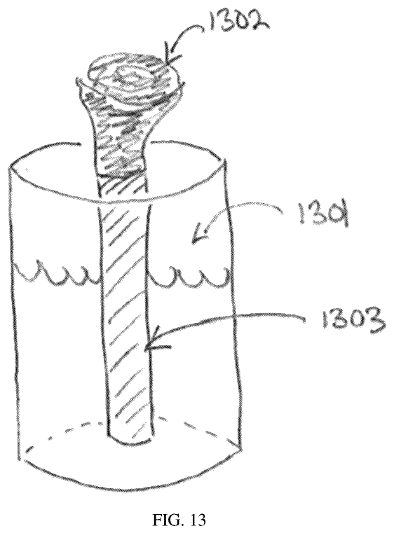

An exemplary system for water purification is depicted in FIG. 13. The system (1300) can include a reservoir (1301) for receiving impure water. The reservoir can be a container made from any water impermeable material, for instance glass or plastic. The system will include at least one solar steamer (1302) including at least one composite as described herein. Water is conveyed from the reservoir to the composite through capillary means (1303). The capillary means (1303) may be made of any material capable of transporting water through a wicking action, for instance a cellulosic material or other hydrophilic polymer. Generally, the capillary means separates the solar steamer from the bulk water, thereby eliminating parasitic heat loss. The capillary means can be supported by a tube or rod (not shown) to ensure its structural integrity over prolonged use, as well as to facilitate attachment of the capillary means to the solar steamer. The support may be made of any durable material, for instance plastic or wood. The reservoir can include a lid with an opening adapted to receive the support material to the plastic tube. The lid may be removable in order to facilitate introduction of impure water. In other embodiments, the lid is not removable, but instead the solar steamer (with or without the supported capillary means) is removed and impure water delivered through the opening. Systems having multiple solar steamers will of course have multiple openings.

The water purification system can also include a condensation surface, where vaporized water is condensed. Condensed water on the condenser surface can be transported, under the force of gravity, cohesion, and/or adhesion, to a collector. In certain embodiments, a plurality of purification systems can direct water to the same collector. The collector can include a recloseable valve to recover the purified water contained within.

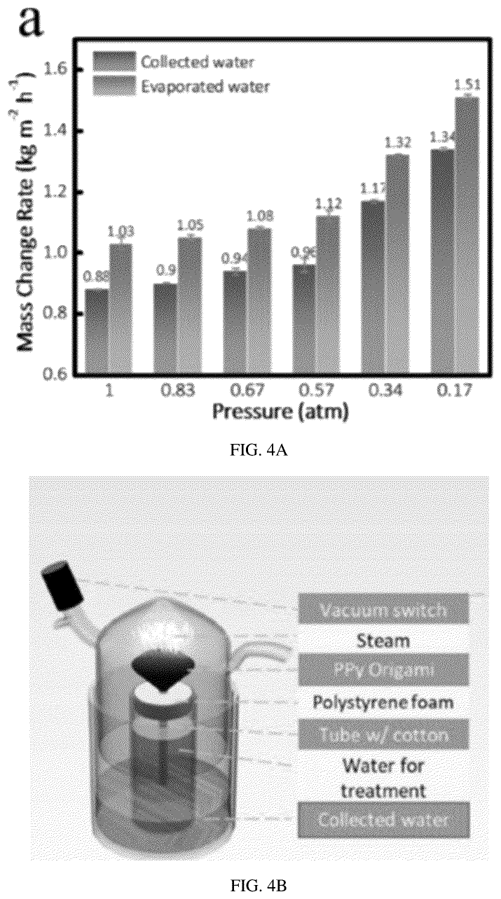

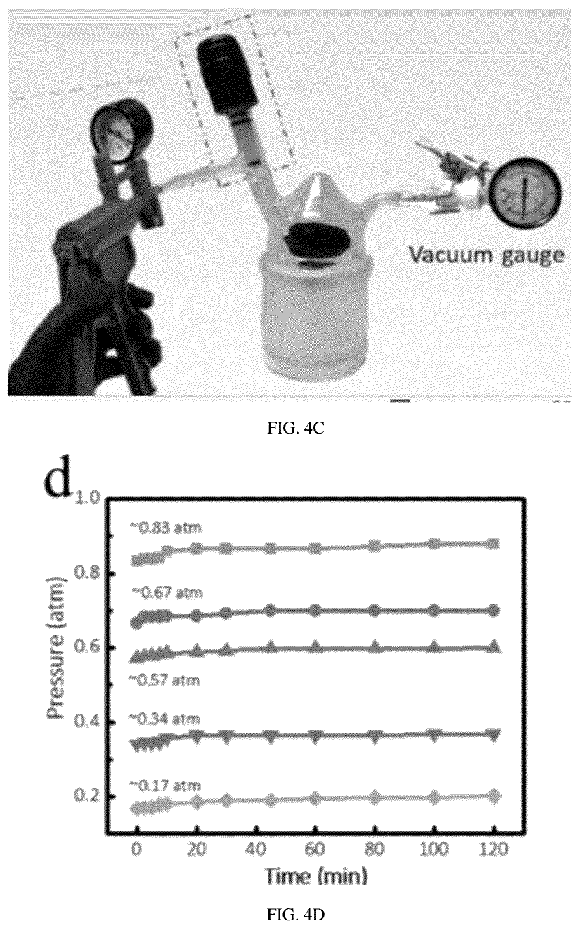

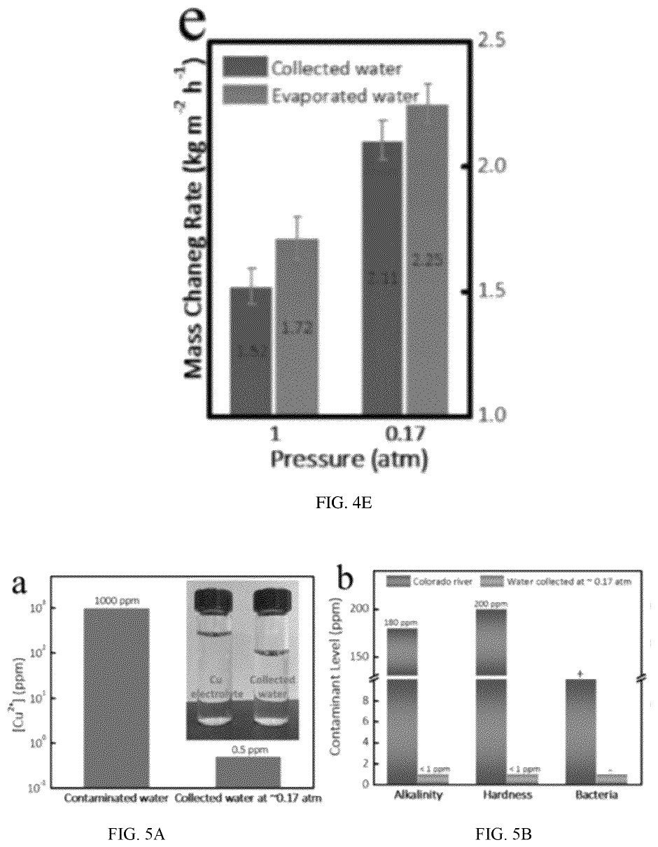

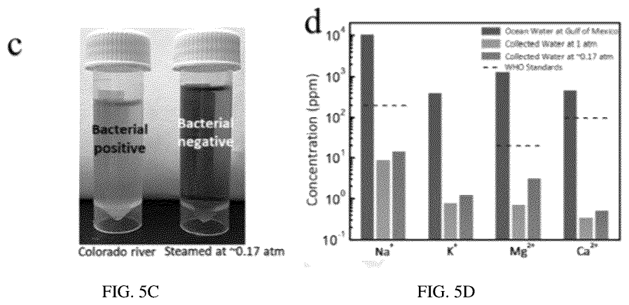

In some embodiments, the water purification is conducted under reduced pressure, thereby lowering the vapor pressure of water and lowering the energy input needed to vaporize the water. An exemplary system is depicted in FIG. 4B. In some embodiments, the condensing surface and collector are physically integrated into the same container, such the top portion defines a condensation surface and the bottom portion defines the collector. In other words, water condenses at the top of the container and then is transferred to the bottom of the container. The container can include a recloseable value for coupling with a pump, for instance one or more of a hand pump, mechanical pump, electric pump, or aspiration pump. The water purification can be conducted at reduced pressure, for instance less than 75% atmosphere, less than 50% atmosphere, less than 35% atmosphere, less than 25% atmosphere, less than 20% atmosphere, less than 15% atmosphere, or less than 10% atmosphere.

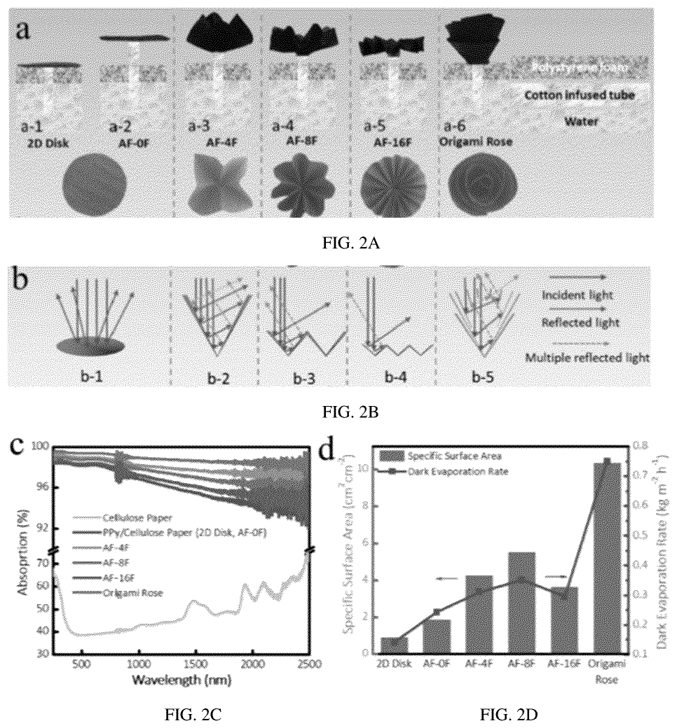

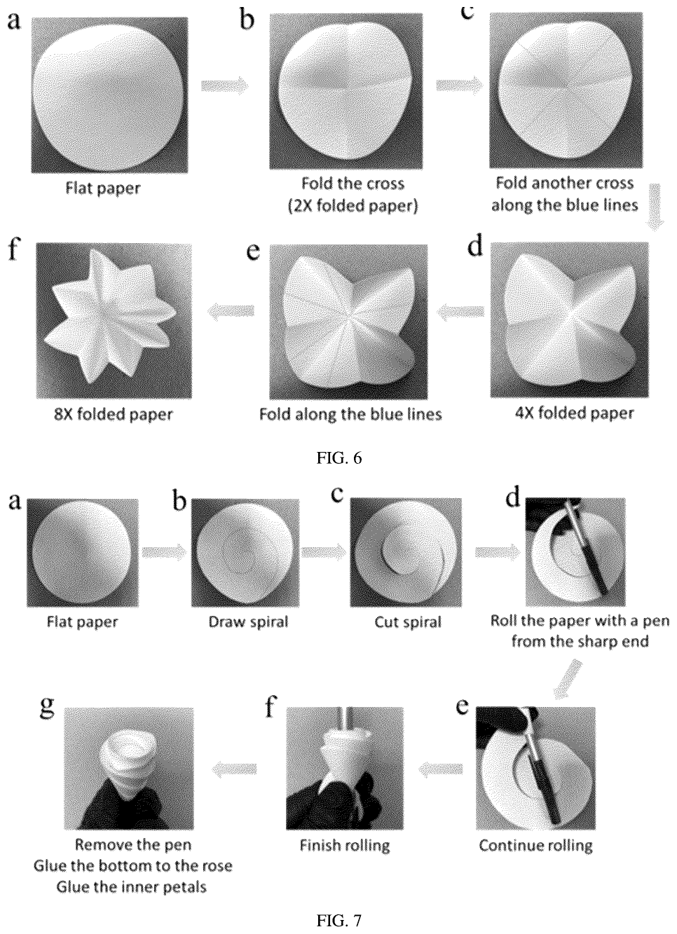

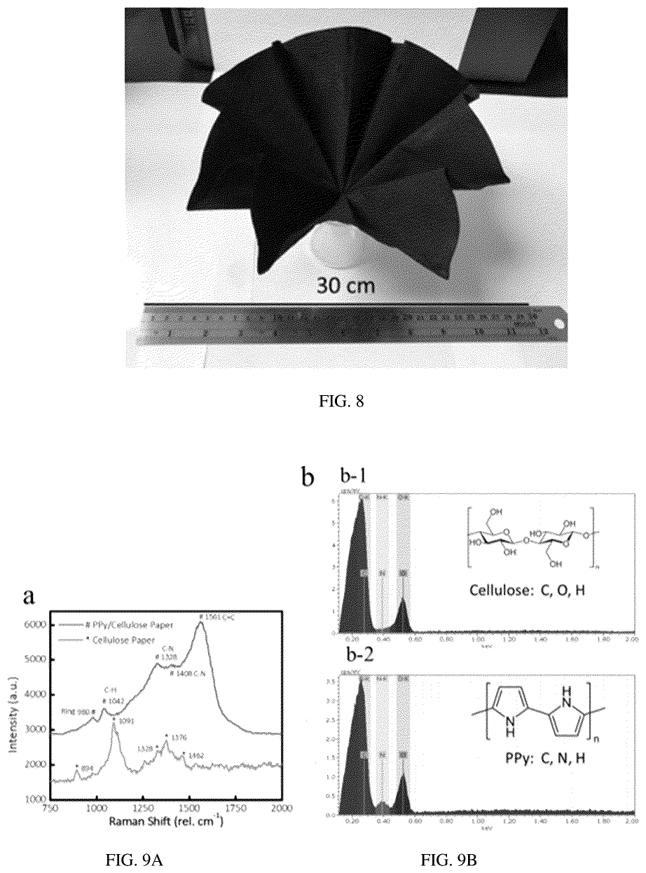

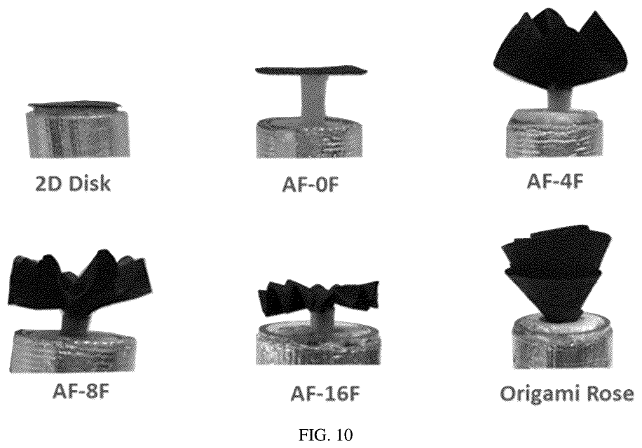

The solar steamers disclosed herein may be folded into three-dimensional shapes to increase the solar absorption efficiency and water evaporation rate. In a completely flat (i.e., two dimensional) steamer, considerable energy is lost due to reflected light. In some embodiments, the solar steamer may be in the shape of a three-dimensional rose as shown in FIGS. 6 and 7. The effective surface area for receiving solar irradiation is greatly increased with such shapes. As shown in FIG. 2, the specific surface area can be increase by a factor of 10 relative to an unfolded composite.

The solar steamer may be continuous, i.e., a rolled, folded, or otherwise shaped single composite sheet. In certain embodiments, the solar steamer (1302) can be a continuous composite sheet rolled one or more times about a central axis, wherein a first end of the rolled sheet has a smaller diameter than the second end. The first end is placed in fluid communication with the wicking means, and the second end extends in space away from the wicking means. The rolled sheet can include additional folds, kinks and sub-rolls in order to minimize the energy lost to reflected light. In preferred embodiments, the central axis can be substantially aligned and parallel to the wicking means.

In other embodiments, the solar steamer may include a plurality of separate composite sheets. The sheets may be bent, folded, or otherwise shaped as described above. The composite sheets may be affixed to one or more supports. Exemplary supports include wires, rods, screens, and funnels. In the case of funnels, the narrow end can house a portion of the wicking means. In certain embodiments, the funnel can be made of the same material described above for the wicking means.

Many naturally occurring flowers can serve as models for the origami composite. In one embodiment, the origami flower is a rose, for instance a Kawasaki rose, for which the process of manufacture is known to the skilled person. Other useful flower shapes include pansy, tulip, anthurium, bluebell, carnations, water lilies, azaleas, sunflowers, violets, primroses, dahlias, lotuses, cherry blossoms, hyacinth, daffodils, irises, lilies, and narcissus (daffodil). Instructions for preparing such shapes may be found in FLOWER ORIGAMI, Joost Langevald, Thunder Bay Press (2012), the contents of which are hereby incorporated in its entirety. In other embodiments, a simplified flower may be prepared by curling and folding corner portions from blintz bases, including triple (i.e., 3-fold) blintz bases, 4-fold, 5-fold, six fold or even more.

The composite can be made hydrophobic by ultrasonically irradiating the substrate in a suitable solvent. For instance, the hydrophilic substrate can be ultrasonically irradiated in a protic polar solvent, e.g., ethanol, propanol, isopropanol, butanol and the like. The resulting hydrophobic sponges can be used to sequester hydrophobic materials from watery mixes, e.g., oil spills, industrial spills, etc. The hydrophobic sponges can be contacted with a watery mix for a time sufficient to absorb the hydrophobic material, e.g., oil, gasoline, diesel fuel, hydrocarbon solvents, and the like. The sponge may be removed, and the absorbed hydrocarbon retrieved from the absorbent.

### Examples

The following examples are for the purpose of illustration of the invention only and are not intended to limit the scope of the present invention in any manner whatsoever.

### Fabrication of PPy Origami.

Three pieces of cellulose filter paper (11 cm in diameter) or folded papers (either artificial flower or origami rose design) are soaked in pyrrole solution (pyrrole, 1 mL; deionized water, 300 mL) and stirred at 280 rpm for 10 minutes. Then, ammonium persulfate (APS) solution (APS, 3.265 g; deionized water, 50 mL) is gradually added into the pyrrole solution. The reaction is sustained for 6 hours with the same stirring speed. Finally, the PPy coated cellulose paper or PPy origami is taken out and rinsed with deionized water and ethanol alternatively for three times, followed by 6-hour drying in a vacuum oven at 60° C. The folding processes for different origami structures and the origami rose are illustrated in FIG. 6 and FIG. 7, respectively.

### Low-Pressure Solar Steaming and Collection

The body of the collection device is made of Pyrex glass. Ground glass is used in the contact area of the condensation cover and outer basin. Before experimental studies, the PPy origami is placed in the inner vial and the condensation cover is assembled on the system and sealed with Vaseline. Then a portable hand-operated pump and a vacuum gauge are connected to the system. After pumping to a designated vacuum pressure, the vacuum switch is turned off to maintain the low-pressure condition inside the collection system. Finally, the solar simulator is switched on. The pressure versus steaming time is recorded with the attached vacuum gauge.

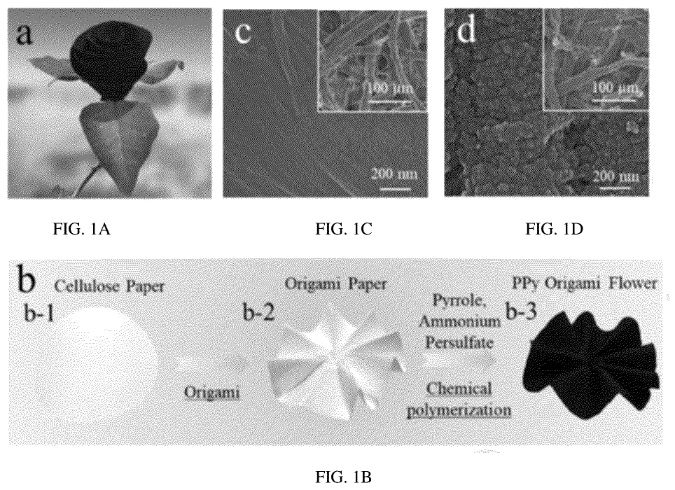

The pristine cellulose paper is a monolithic porous structure with interconnected microstruts as shown in the scanning electron microscopy (SEM) images [FIG. 1c]. After being stained with black PPy, the composite maintains the interlinked and macroporous morphology [FIG. 1d], which provides continuous channels for drawing water. It clearly reveals the presence of PPy nanograins deposited on the microstruts of cellulose paper, where the surface turns rough. The Raman spectrum confirms the successful coating of PPy on cellulose paper [FIG. 9a]. The Raman peaks obtained for PPy origami mainly come from PPy. The pronounced peak at 1561 cm⁻¹ arises from the strong C═C backbone stretching. The peaks at 1328 cm⁻¹ and 1408 cm⁻¹ correspond to the antisymmetric C—N stretching of PPy, whereas the peak located at 1042 cm⁻¹ can be assigned to the C—H in-plane bending. Furthermore, its ring deformation vibration generates the peak at 980 cm⁻¹. The co-existence of nitrogen and oxygen peaks after PPy synthesis shown in the energy-dispersive x-ray spectroscopy (EDS) further corroborates the chemistry of PPy origamis [FIG. 9b], i.e., PPy [(C₄H₂NH)ₙ]@cellulose paper [(C₆H₁₀O₅)ₙ]. The cellulose paper exhibits superhigh hydrophilicity, allowing itself to be readily stained by PPy. This hydrophilicity is maintained during polymerization, ensuring high permeability during solar steaming operations.

We folded PPy papers into origamis to improve light absorption by the PPy-paper composite. As illustrated in FIG. 2b, the number of folds and the height of petals are critical parameters for providing multi-round reflections. Furthermore, a folded structure with greater depth exhibits a higher capability in supporting internal light reflections [FIG. 2b]. Herein, AF-4F, the origami with the greatest depth, exhibits the highest optical absorption of 98% followed by AF-8F (97.3%) and AF-16F (96.2%).

Results in FIG. 2d suggest that the dark evaporation rate monotonically increases with the surface area/projected area of an origami. For example, in the configuration of a planar AF-OF PPy paper, where both the top and bottom surfaces are exposed, corresponding to a measured increase of specific surface area by 1.94 times compared to that of the 2D disk in FIG. 2d (the partial part of the bottom side is connected to the cotton infused tube, so it is not exactly two times). The dark evaporation rate follows the trend and is enhanced by 1.71 times from 0.14 to 0.24 kg m⁻² h⁻¹ [FIG. 2d]. However, for solar steamers with more complicated 3-D geometries, the dark evaporation rate is determined not only by the specific surface area but also by vapor dissipation pathways from the solar absorber. For instance, after folding PPy paper into origami structures of AF-4F and AF-8F, the specific surface area can be boosted by 4.3 times and 5.6 times, respectively [FIG. 2d]. The corresponding dark evaporation rates are improved by 2.21 and 2.5 times to 0.31 kg m⁻² h⁻¹ and 0.35 kg m⁻² h⁻¹, respectively, compared to that of the 2D Disk.

The solar-thermal energy conversion efficiency (η) is obtained with the equation η=Δ\dot{m}H_{Lv}/Pᵢₙ. Here the mass change rate (Δ\dot{m}) is given by Δ\dot{m}=\dot{m}_{w/absorber under sun}−\dot{m}_{w/absorber in dark}, and Pᵢₙ and H_{LV} are the intensity of simulated solar light irradiating vertically on the absorber surface and the enthalpy of liquid-vapor phase transition at the operation temperature, which is calculated based on the Hess' Law in thermodynamics.

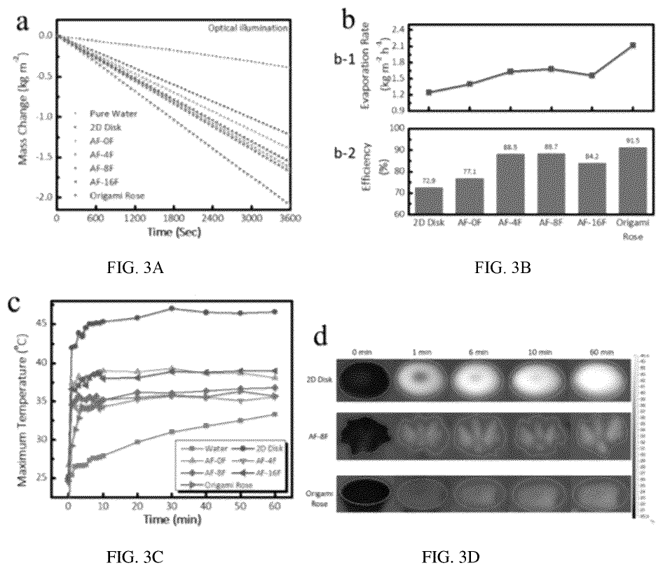

In our work, we utilize the slope of the mass loss curve in FIG. 3a at the second 30 minute interval to estimate the evaporation rate, during which the water has already been heated to the operating temperature. So we only consider the latent heat for a conservative efficiency calculation. In order to obtain an accurate latent heat at the specific temperature, we construct a multistep equilibrium reaction route according to the Hess' Law.

$${h}_{lv , {T}_{s}} = {\int }_{{T}_{s}}^{100 ° C .} {C}_{p , l} dT + {h}_{lv , 100 ° C .} + {\int }_{100 ° C .}^{{T}_{s}} {C}_{p , v} dT$$

Here, hₗᵥ is the latent heat, C_{p,l} and C_{p,v} are the heat capacity of liquid water and water vapor, respectively. h_{lv,100° C.}=2257 J·g⁻¹, C_{p,l}=4.1813 J·K⁻¹·g⁻¹, C_{p,v}=(3.470+1.45×10⁻³×T+0.121×10⁵×T⁻²)·R (J·K⁻¹·mol⁻¹), R=8.314 J·K⁻¹·mol⁻¹, T is the temperature in Kelvin scale.

| Operating temperature of | Latent heat |
|---|---|
| solar steamers T_{S} (° C.) | h_{lv, T}_{_{S}} (J · g⁻¹) |
| 33 | 2411 |
| 34 | 2409 |
| 35 | 2407 |
| 36 | 2404 |
| 37 | 2402 |
| 38 | 2400 |
| 39 | 2397 |
| 40 | 2395 |
| 41 | 2393 |
| 42 | 2390 |
| 43 | 2388 |
| 44 | 2386 |
| 45 | 2383 |
| 46 | 2381 |

The mass flux of water generated by solar steamer (\dot{m}) relies on two factors, i.e., (1) the vaporization rate of water (v), and (2) evaporation area Aₑᵥₚ, where \dot{m}=ν*Aₑᵥₚ/Aₚᵣⱼ, Aₚᵣⱼ is the projected area of incident light. Note that the evaporation rate referred to in solar steaming tests is actually the mass flux (\dot{m}) rather than the vaporization rate (v) discussed here. The vaporization rate refers to the number of water molecules that change phase from liquid to gas per unit time, which mainly depends on the temperature of the liquid water. The high operating temperature of a solar steamer (Tₛ) is favorable for the vaporization of water on a hot surface. If the photothermal material is a 2D structure, Aₑᵥₚ=Aₚᵣⱼ, then \dot{m}=ν. This means the evaporation rate of a 2D solar steamer is only positively related to its operating temperature. It is also validated in the control experiment of pure water and 2D PPy paper in our work. Due to the excellent optical absorption and photothermal conversion of PPy, the operating temperature of 2D PPy is ˜46° C. [FIG. 3c, red dots], which is almost 23° C. higher than that of pure water [FIG. 3c, grey dots]. Hence, the evaporation of water can be substantially facilitated by such a high temperature.

However, in the case of 3D solar steaming materials (Aₑᵥₚ>Aₚᵣⱼ), the evaporation rate monotonically increases with the evaporation surface area. With the increased surface area, the 3D solar steamer provides more pathways for water vaporization compared to that of 2D structures, which converts heat into water evaporation much more efficiently. As a result, the surface temperature is lower on the 3D steamer than that of the 2D steamer since there is less excess heat available to maintain a high surface temperature on the 3D solar steamer. This lowered surface temperature is advantageous in saving radiative energy loss to the surroundings, which further helps the overall efficiency of the 3D steamer.

As shown in FIG. 3c, the operating temperatures of all folded PPy origamis (AF-4F, -8F, -16F and rose) are lower than that of AF-0F because of their 3D structure enhanced energy conversion efficiency from heat to water evaporation. For example, both AF-4F and AF-8F deliver an operating temperature of ˜36° C. with an energy conversion efficiency of ˜89% in comparison to that of AF-0F (˜46° C., ˜73%) and AF-16F (˜39° C., ˜86%). Though the operating temperature on the top surface of the origami rose is at a similar level of that of AF-4F and AF-8F, the almost complete optical absorption and much larger surface areas for water evaporation enable origami rose to provide an even higher solar-thermal conversion efficiency of 91.5%.

The condensation occurs when the water vapor collides with a liquid or solid surface and changes to liquid water. In a low-pressure steaming and collection system, the water evaporation is facilitated because of the reduced pressure, which drives the phase change from liquid water to vapor to reach an equilibrium. With the increased number of water vapor molecules and fewer air molecules due to the generated low pressure, the probability of collision between water vapor molecules and the condensation glass cover also increases remarkably. Therefore, the condensation rate is improved in the low-pressure enclosed system.

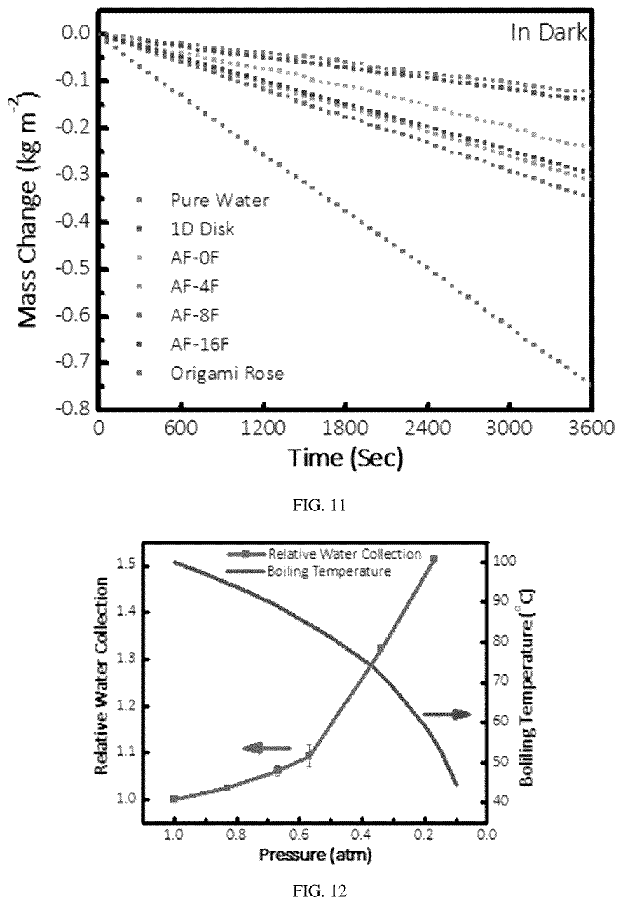

The low pressure enhanced water evaporation can be also understood from the perspective of vacuum induced boiling temperature decrease. This is supported by the Clausius-Clapeyron equation

$$\frac{dP}{dT} = \frac{L}{T Δ L} {⟹}^{ideal gas} ln \frac{{P}_{2}}{{P}_{1}} = \frac{Δ H}{R} ( \frac{1}{{T}_{1}} - \frac{1}{{T}_{2}} ) ,$$

where P is the pressure, T is the boiling temperature, ΔH is the latent heat, and V is the volume. As a result, at an equilibrium condition, the boiling temperature of water descends with the decrease of pressure, which is plotted in a red line in FIG. 12. It is found that at a high-pressure range (0.57-1.0 atm), the water collection rate was enhanced but not significantly. Once the pressure is reduced to a low range (0.17-0.57 atm), water collection is greatly enhanced. This result agrees qualitatively with the dependence of boiling temperature on external pressure, although our system is dynamic. For instance, the boiling temperature decreases 15° C. when the pressure is lowered from 1 to 0.57 atm, while it drops by 29° C. upon a pressure reduction from 0.57 to 0.17 atm.

In our tests, a hand-operated vacuum pump was utilized to achieve low pressure. In order to estimate the consumption of this energy, we employed an electric pump (Kozyvacu TA350, power=¼HP=186.5 W) to obtain the same level of low pressure in the enclosed collection system. It is found that the electric pump only needs 5 seconds to reduce the pressure of the collection system from 1 atm to ˜0.17 atm. Therefore, an energy consumption of 932.5 J (186.5 watts×5 sec) can be estimated. Note that this low pressure can be well maintained for a long duration, i.e. at least 2 hrs during operation [FIG. 4d]. The corresponding energy consumption is still just 932.5 J.

The energy conversion efficiency is calculated with the following equation by including the energy utilization by the pump in the standard equation:

$$η = \frac{( {\dot{m}}_{w / absorber under sun} - {\dot{m}}_{w / absorber in dark} ) \times {t}_{sun} \times {A}_{absorber} \times {H}_{LV}}{{P}_{sun} \times {t}_{sun} \times {A}_{absorber} + {P}_{pump} \times {t}_{pump}}$$

Here, \dot{m} is the evaporation rate, a normalized value of area and time; tₛᵤₙ is solar exposure time; A_{absorber} is the projection area of a solar steamer, H_{LV} is enthalpy of liquid-vapor phase transition; Pₛᵤₙ is solar intensity (=1000 W m⁻²); Pₚᵤₘₚ is power of electrical pump (=186.5 W), and tₚᵤₘₚ is pump operation time (=5 s).

Then, taking the AF-8F as an example, the energy efficiency can be obtained.

$${\dot{m}}_{w / AF - 8 F in dark} = 0.35 kg {m}^{- 2} {h}^{- 1} , {A}_{AF - 8 F} = 10.12 {cm}^{2} . {H}_{LV} = 2402 J \cdot {g}^{- 1}$$

1. At an ambient pressure (1 atm) in the enclosed collection system,

\dot{m}_{w/AF-8F under sun}=0.88 kg m⁻² h⁻¹,tₚᵤₘₚ=0 s.

Therefore,

$${η}_{1 atm} = \frac{( 0.88 - 0.35 ) kg {m}^{- 2} {h}^{- 1} \times 2402 J \cdot {g}^{- 1} \times {t}_{sun} \times {A}_{absorber}}{1000 W {m}^{- 2} \times {t}_{sun} \times {A}_{absorber}} = 35.3 \%$$

2. At the low pressure (˜0.17 atm) in the enclosed collection system,

\dot{m}_{w/AF-8F under sun}=1.51 kg m⁻² h⁻¹,tₚᵤₘₚ=5 s.
2.1. When the low-pressure test is operated for 1 hour (tₛᵤₙ=1 h),

$${η}_{0.17 atm , 1 h} = \frac{( 1.51 - 0.35 ) kg {m}^{- 2} {h}^{- 1} \times 2402 J \cdot {g}^{- 1} \times 1 h \times 10.12 {cm}^{2}}{1000 W {m}^{- 2} \times 1 h \times 10.12 {cm}^{2} + 186.5 W \times 5 s} = 61.6 \%$$

2.2. If the low-pressure test is operated for 2 hours (tₛᵤₙ=2 h), the energy consumption by the pump is the same:

$${η}_{0.17 atm , 2 h} = \frac{( 1.51 - 0.35 ) kg {m}^{- 2} {h}^{- 1} \times 2402 J \cdot {g}^{- 1} \times 2 h \times 10.12 {cm}^{2}}{1000 W {m}^{- 2} \times 2 h \times 10.12 {cm}^{2} + 186.5 W \times 5 s} = 68.6 \%$$

With the same method, we can estimate all the efficiency values for the origami rose solar steamer as follows: η_{1 atm}=64.7%, η_{0.17 atm,1 h}=74.6%, η_{0.17 atm,2 h}=85.5%.

The above results clearly indicate the remarkable effect of obtaining overall high energy efficiency through a solar steamer in a low-pressure collection system. The longer the low-pressure system operates, the higher energy efficiency the system will show.

### Preparation of Hydrophobic Absorbent

Commercial melamine sponges are cut in the 3 cm*3 cm*0.5 cm cuboid (thickness can be adjusted). DI water (500 mL), stir bar and trimmed sponges (8 pieces) are combined in a clean beaker followed by adding pyrrole monomer (2 mL) in the solution. Then stir for 2 h (220-280 rpm) until there is no yellow pyrrole floating on the suspension. At the same time of stirring, ammonium persulfate (APS, 6.53 g) is dissolved in DI water (50 mL) in a centrifuge tube. After 2-hour stirring, the APS solution is transferred into the pyrrole solution and mixed by continuing the stirring for 3 h (220-280 rpm). Then, the sponges are washed by the DI water and ethanol alternatively for 3 times. Finally, the PPy coated sponges are dried in a vacuum oven at a temperature no more than 70° C. overnight.

Hydrophobicity modification by Ultrasonic treatment: the obtained PPy sponge is immersed in pure ethanol (150 mL ethanol in 500 mL plastic bottle). Then the bottle containing PPy sponge is transferred to a sonicator and treated with ultrasonication for 1 hour. Next, the sponge is rinsed by ethanol for 2 times and dried in a vacuum oven at 70° C. for 1 h. The hydrophobic PPy sponge is obtained.

### Further Embodiments

1. A conductive polymer entangled in a flexible thin-film substrate, obtained by a process comprising providing a flexible thin-film substrate in a solution, and polymerizing a suitable monomer in said solution.
2. The entangled conductive polymer according to a preceding embodiment, wherein the flexible thin-film substrate comprises air-laid paper, polysulfone membranes, cellulose papers, a polyvinylidene fluoride (PVDF) membrane, a craft paper, a printing paper, thin sponge, cotton cloth, or combination thereof.
3. The entangled polymer according to a preceding embodiment, wherein the thin-film substrate is in the shape of multiple-layer 3D structures.
4. The entangled polymer according to a preceding embodiment, in the shape of a cylinder, a multiple-layer 3D structure, a structure resembling plants such as roses, or a combination thereof.
5. The entangled polymer according to a preceding embodiment, wherein the suitable monomer comprises a pyrrole, an aniline, a thiophene, a furan, or a combination thereof.
6. The entangled polymer according to a preceding embodiment, wherein the suitable monomer comprises pyrrole.
7. The entangled polymer according to a preceding embodiment, wherein the polymerizable monomer is provided at a concentration of 0.01-2 mmol per cm² of substrate.
8. The entangled polymer according to a preceding embodiment, wherein the conductive polymer comprises a poly(aniline), poly(pyrrole), poly(thiophene), poly(seleophene), poly(furan), or poly(azepine).
9. The entangled polymer according to a preceding embodiment, wherein the conductive polymer comprises a repeating unit of Formula (2a) or Formula (2b):

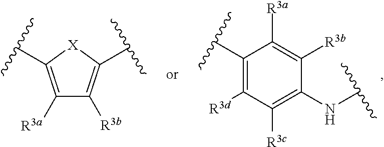

wherein X is NH, S, O, Se;
R^{3a}, R^{3b}, R^{3c}, and R^{3d} are independently selected from hydrogen, C₁₋₈alkyl, C₁₋₈alkoxy, and wherein either R^{3a} and R^{3b} or R^{3c} and R^{3d} may together form a ring.
10. An absorbent, comprising a conductive polymer entangled in a sponge substrate.
11. The absorbent according to a preceding embodiment, obtained by a process comprising a providing a sponge substrate in a solution, and polymerizing a suitable monomer in said solution to entangle the sponge substrate with a conductive polymer, and then ultrasonically irradiating the sponge substrate.
12. The absorbent according to a preceding embodiment, wherein the sponge substrate is ultrasonically irradiated in a protic polar solvent.
13. The absorbent according to a preceding embodiment, wherein the sponge substrate is ultrasonically irradiated in ethanol.
14. The absorbent according to a preceding embodiment, wherein the sponge substrate comprises a polyurethane, a polyester, or a melamine sponge.
15. The absorbent according to a preceding embodiment, wherein the suitable monomer comprises a pyrrole, an aniline, a thiophene, a furan, or a combination thereof.
16. The absorbent according to a preceding embodiment, wherein the suitable monomer comprises pyrrole.
17. A method of separating a hydrophobic substance from an aqueous mixture, comprising contacting the absorbent according to a preceding embodiment with the aqueous mixture.
18. The method according to a preceding embodiment, further comprising removing the absorbed hydrophobic substance from the absorbent.
19. The method according to a preceding embodiment, wherein the hydrophobic substance comprises oil, gasoline, diesel fuel, hexane, methylbenzene, assorted hydrocarbons, or combination thereof.
20. A water purification system, comprising:
   a) a reservoir for receiving impure water,
   b) a collector for receiving purified water,
   c) a solar steamer, wherein the solar steamer is disposed between the reservoir and collector;
   d) a capillary material in fluid communication with, and extending between, the solar steamer and reservoir, and
   e) a condensation surface disposed between the solar steamer and the collector, wherein condensed water is conveyed to the collector.
21. The system according to a preceding embodiment, wherein the system comprises a recloseable valve for coupling to a pump.
22. The system according to a preceding embodiment, wherein the system is in a low-pressure or vacuum condition when working with the optimal performance.
23. The system according to a preceding embodiment, wherein the pump comprises a hand-operated pump, a mechanical pump, an electric pump, or combination thereof.
24. The system according to a preceding embodiment, wherein condensed water is conveyed to the collector via cohesion, adhesion, gravitation, or a combination thereof.
25. The system according to a preceding embodiment, wherein the capillary material comprises a cellulosic material.
26. The system according to a preceding embodiment, wherein the solar steamer comprises a conductive polymer entangled with a substrate.
27. The system according to a preceding embodiment, wherein the conductive polymer comprises polypyrrole.
28. The system according to a preceding embodiment, wherein the solar steamer has an energy conversion efficiency of at least 85%, at least 87.5%, at least 90%, or at least 92.5%.
29. The system according to a preceding embodiment, wherein the solar steamer comprises from 0.1-2 g conductive polymer per cm² of substrate.
30. The system according to a preceding embodiment, wherein the solar steamer is in the 3D shape and made by origami folding.
31. The system according to a preceding embodiment, wherein the solar steamer of origami shape comprises a cylinder, a multiple-layer 3D structure, a structure resembling plants such as roses, or a combination thereof.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1-9. (canceled)

10. An absorbent, comprising a conductive polymer entangled in a sponge substrate, obtained by a process comprising a providing a sponge substrate in a solution, and polymerizing a monomer in said solution to prepare a conductive polymer entangled the sponge substrate, and then ultrasonically irradiating the sponge substrate.

11. (canceled)

12. The absorbent according to claim 10, wherein the sponge substrate is ultrasonically irradiated in a protic polar solvent.

13. The absorbent according to claim 10, wherein the sponge substrate is ultrasonically irradiated in ethanol.

14. The absorbent according to claim 10, wherein the sponge substrate comprises a polyurethane, a polyester, or a melamine sponge.

15. The absorbent according to claim 10, wherein the monomer comprises a pyrrole, an aniline, a thiophene, a furan, or a combination thereof.

16. The absorbent according to claim 10, wherein the monomer comprises pyrrole.

17. A method of separating a hydrophobic substance from an aqueous mixture, comprising contacting the absorbent according to claim 10 with the aqueous mixture.

18. The method according to claim 17, further comprising removing the absorbed hydrophobic substance from the absorbent.

19. The method according to claim 17, wherein the hydrophobic substance comprises oil, gasoline, diesel fuel, hexane, methylbenzene, assorted hydrocarbons, or combination thereof.

20. A water purification system, comprising:
a) a reservoir for receiving impure water;
b) a collector for receiving purified water;
c) a solar steamer, wherein the solar steamer is disposed between the reservoir and collector;
d) a capillary material in fluid communication with, and extending between, the solar steamer and reservoir; and
e) a condensation surface disposed between the solar steamer and the collector, wherein condensed water is conveyed to the collector;
wherein the solar steamer comprises a conductive polymer entangled with a thin-film flexible substrate, obtained by a process comprising providing a flexible thin-film substrate in a solution, and polymerizing a monomer in said solution to prepare a conductive polymer entangled in the flexible thin-film substrate.

21. The system according to claim 20, wherein the system comprises a recloseable valve for coupling to a pump.

22. The system according to claim 20, wherein the system is operated in a low-pressure or vacuum condition.

23. The system according to claim 21, wherein the pump comprises a hand-operated pump, a mechanical pump, an electric pump, or combination thereof.

24. The system according to claim 20, wherein condensed water is conveyed to the collector via cohesion, adhesion, gravitation, or a combination thereof.

25. The system according to claim 20, wherein the capillary material comprises a cellulosic material.

26. (canceled)

27. The system according to claim 20, wherein the conductive polymer comprises polypyrrole.

28. The system according to claim 20, wherein the solar steamer has an energy conversion efficiency of at least 85%, at least 87.5%, at least 90%, or at least 92.5%.

29. The system according to claim 27, wherein the solar steamer comprises from 0.1-2 g conductive polymer per cm² of substrate.

30. The system according to claim 20, wherein the solar steamer is in the 3D shape and made by origami folding.

31. The system according to claim 30, wherein the solar steamer of origami shape comprises a cylinder, a multiple-layer 3D structure, a structure resembling plants such as roses, or a combination thereof.
